(19) United States
(12) Patent Application Publication
(10) Pub. No.: US 2013/0115445 A1
(43) Pub. Date: May 9, 2013

(54) GLASS ARTICLE COATED WITH AN ENAMEL-BASED LAYER

(71) Applicants: Thomas Devaux, Villers la Tour (BE); David Pierre, Bruxelles (BE); Ronny Pieters, Bruxelles (Ganshoren) (BE); Franck Verraes, Oostkamp (BE)

(72) Inventors: Thomas Devaux, Villers la Tour (BE); David Pierre, Bruxelles (BE); Ronny Pieters, Bruxelles (Ganshoren) (BE); Franck Verraes, Oostkamp (BE)

(73) Assignee: AGC Glass Europe, Bruxelles (Watermael-Boitsfort) (BE)

(21) Appl. No.: 13/805,507

(22) PCT Filed: Jul. 7, 2011
(86) PCT No.: PCT/EP2011/061489

§ 371 Date: Dec. 19, 2012

(30) Foreign Application Priority Data
Jul. 9, 2010 (BE) BE 2010/0419

(51) Int. Cl. C03C 17/00

(52) U.S. Cl. CPC C03C 17/009
USPC 428/335; 428/428

(57) ABSTRACT

The invention relates to an article made of coated glass, in particular an article comprising a glass sheet covered with an enamel coating. The glass article of the invention is resistant transport and handling, can be used in a twin application and can be tempered, i.e. can be heat-treated with a view to later tempering same. Specifically, the article of the invention includes: (i) at least one glass sheet; (ii) an enamel coating on at least one of the surfaces of the glass sheet; and (iii) at least one wax provided in and/or on said enamel coating.

### 1. FIELD OF THE INVENTION

The present invention relates to a coated glass article, in particular an article comprising a glass sheet covered by an enamel-based coating. The glass article of the invention is toughenable, i.e. it can be thermally treated with a view in particular to its subsequent toughening.

### 2. SOLUTIONS OF THE PRIOR ART

Numerous types of glass sheets covered by an enamel-based coating are already known in the art. In particular, enamelled glass sheets that cannot be toughened are also known. The product Colorbel®, a toughened glazing in which one of the faces is covered with a coloured vitrified enamel, is quoted as an example. However, before the toughening and/or vitrification (sintering) of the enamel, the coating of this product does not have a sufficient mechanical strength to enable it to withstand transport, handling and/or storage before its thermal treatment. It is therefore necessary for this product that the toughening is conducted practically immediately after production and preferably on the same production line, which constitutes a severe limitation from an industrial viewpoint.

Nevertheless, the (principally decorative) applications of such types of glass sheets require toughened glass for safety reasons.

Consequently, different products have been developed that enable these disadvantages to be resolved. In particular, the international patent application WO 2007/135192 A1 describes a glass sheet coated with an enamel-based layer, the mechanical strength of which before toughening was improved. In fact, this type of product enables scratches and damage to the layer itself to be prevented. Nevertheless, even if the layer itself remains intact, this type of product is subject to damage in appearance during the manufacturing process and above all its machining: the covered face of the enamel-based layer has in fact dark or even black marks on its surface left by (generally dirty) belts of transport systems in the factories such as rubber belts on cutting tables or transport belts of automatic grinders. Treatments such as washing by hand or even by industrial washing machine often prove inadequate. Moreover, these marks unfortunately remain after the thermal treatment with a view to toughening (˜670° C.). However, because the enamel-based layer is very often opaque, these marks are not visible when one looks through the glass sheet from the non-coated side and therefore they are not disturbing in the case of a single-face application of the glass product (e.g. a wall covering). However, there is still impairment of its appearance in the case of a dual-face application of the glass product such as a partition or a balustrade, for example, and this type of product is therefore unsuitable for sale for this type of application. Moreover, this visual impairment is all the more significant when the colour created by the enamel-based layer is light.

### 3. OBJECTIVES OF THE INVENTION

The objective of the invention in particular is to overcome these disadvantages by solving the technical problem, i.e. to obtain a glass sheet bearing an enamel-based coating that is capable of undergoing a thermal treatment, in particular with a view to its subsequent toughening, and is able to withstand transport and handling.

In particular, an objective of the invention in at least one of its embodiments is to provide a glass sheet bearing an enamel-based coating, which after having been toughened can be used for dual-face applications.

More specifically, an objective of the invention in at least one of its embodiments is to provide a glass sheet bearing an enamel-based coating, which after having been toughened does not or no longer has marks resulting from transfer tools (e.g. conveyor belts), transformation tools (e.g. grinders) and/or handling tools.

Finally, another objective of the invention is to provide a solution to the disadvantages of the prior art that is simple, quick and economical.

### 4. OUTLINE OF THE INVENTION

In accordance with a particular embodiment, the invention relates to an article comprising
(i) at least one glass sheet;
(ii) an enamel-based coating on at least one of the surfaces of said glass sheet; and
(iii) at least one wax in and/or on said coating.

Hence, the invention rests on a completely novel and inventive approach since it allows the disadvantages of the glass products of the prior art to be overcome and the set technical problem to be solved. In fact the inventors have proved that it was possible by combining an enamel-based coating and a wax to obtain an enamelled glass article (i) which is capable to undergoing a thermal treatment in particular with a view to being subsequently toughened, (ii) has a sufficient mechanical strength before toughening and (iii) which after being toughened no longer has any marks (resulting from transfer, transformation and/or handling tools) present before the thermal treatment.

Therefore, the inventors have proved that the presence of wax in and/or on the enamel-based coating allowed such marks to be subsequently eliminated (during a thermal treatment). This result is surprising in that the use of wax in enamelling is generally known but for improving the anti-adhesive and sliding properties of its surface and not as an agent for removing marks on a coating by means of a thermal treatment.

### 5. LIST OF FIGURES

Other characteristics and advantages of the invention will become clearer upon reading the following description of a preferred embodiment given as a simple non-restrictive illustrative example and of the attached figures, wherein:

FIG. 1 shows a photograph of an enamelled article according to the prior art;

FIG. 2 shows photographs of an enamelled article according to an embodiment of the invention;

FIG. 3 shows photographs of an enamelled article according to another embodiment of the invention.

### 6. DESCRIPTION OF AN EMBODIMENT OF THE INVENTION

The article according to the invention is formed from a glass sheet. The glass according to the invention can belong to various categories. Thus, the glass can be a soda-lime glass, a boron glass, a lead glass, a glass containing one or more additives distributed uniformly within its bulk, such as e.g. at least one inorganic colouring agent, an oxidising compound, a viscosity-regulating agent and/or a melting agent. The glass of the invention is preferably a soda-lime glass. The glass of the invention can be a float glass, a drawn glass or a patterned glass. It can be clear, extra-clear, solidly coloured, sanded and/or frosted. The term “soda-lime glass” is used here in its broad sense and relates to any glass that contains the following base components (expressed in percentages by total weight of the glass):

| | |
|---|---|
| SiO₂ | 60 to 75% |
| Na₂O | 10 to 20% |
| CaO | 0 to 16% |
| K₂O | 0 to 10% |
| MgO | 0 to 10% |
| Al₂O₃ | 0 to 5% |
| BaO | 0 to 2% |
| BaO + CaO + MgO | 10 to 20% |
| K₂O + Na₂O | 10 to 20% |

It also relates to any glass containing the above base components that can additionally contain one or more additives.

According to an embodiment of the invention, the glass sheet is a sheet of float glass. The glass sheet is preferably a sheet of soda-lime float glass. Still according to this embodiment, the sheet of float glass of the invention can have a thickness varying e.g. from 2 to 10 mm.

The article of the invention comprises an enamel-based coating on at least one of the surfaces of the glass sheet. According to the invention the coating can extend continuously over substantially the whole of the surface of the glass sheet, e.g. over more than 90% of the surface, preferably over more than 95% of the surface. Alternatively, the coating can partially cover the surface of the glass sheet.

According to an embodiment of the invention the coating has a decorative function. The coating is preferably opaque. The coating is also preferably coloured (including white and black).

According to the invention the enamel-based coating comprises a powder formed from a vitreous matrix (or glass fit) and inorganic pigments suspended in a medium. The medium according to the invention is preferably organic in nature and preferably comprises thermo-crosslinkable and/or photo-crosslinkable elements (through infrared or ultraviolet rays).

The invention covers (i) the enamel-based coating after drying, i.e. after elimination of any solvent(s) possibly present in the initial composition and (ii) the enamel-based coating after cross-linkage, if applicable.

According to an embodiment of the invention the enamel-based coating preferably contains 11 to 40% by weight of organic materials. The enamel-based coating preferably does not contain more than 30% by weight of organic materials and more preferred not more than 20% by weight.

To measure the content of organic materials, the coating (a quantity generally in the order of 1 to 2 grams) was removed from the surface of the article after being dried (free from residual solvents) and/or cross-linked and analysed using thermogravimetric analysis (TGA). The analysis was conducted in air from 20° C. to 1000° C. with a temperature increase of 10° C./min. The content of organic materials is determined on the basis of the residue once no further weight loss is observed. The organic material is generally completely burned in the region of 400-500° C.

Such a content of organic materials in the enamel-based coating allows a significant mechanical strength of said coating to be obtained before it is toughened.

The organic material in the enamel-based coating of the invention can comprise at least one compound selected from the following compounds: polyols, alkyds, acrylics, polyacrylics, polyacrylates, polymethacrylates, acrylamides, melamine, polycarbonates, styrenes, vinyl acrylics, urethanes, polyurethanes, polyesters, polyolefins, urethane alkyds, polyurea, amino resins, polyamides, epoxides, epoxy esters, phenolic resins, silicone type resins, PVC, PVB, aqueous resins and reaction products of the aforementioned compounds.

According to the invention the enamel-based coating is preferably in direct contact with the glass sheet. Alternatively, an adhesion-promoting agent can be present between the glass sheet and said coating. The adhesion-promoting agent can contain a silane, for example.

According to the invention, once dried and/or cross-linked the enamel-based coating has a thickness in the range of between 20 and 100 microns. Layer thickness is understood here to mean the average geometric thickness. If the thickness of the coating is too low, this can result in an enamelled glass article not having the desired mechanical strength properties or aesthetic appearance. If it is too high, the drying and/or the cross-linkage cannot be complete and separations/damages of the coating can occur. Such thicknesses can be obtained by one or more applications during the manufacturing process.

The glass article of the invention comprises at least one wax. In general, wax is understood to be an oligomer derived from natural or synthetic polymers. The wax according to the invention is selected from waxes of natural origin, waxes of synthetic origin and mixtures thereof in any proportions whatever. When it is of natural origin, the wax can belong to the category of animal, plant or mineral waxes. Mineral waxes derived from oil are preferred, and more particularly paraffins and microcrystalline waxes. Paraffin waxes consist mainly of linear hydrocarbon chains. They mainly comprise normal paraffin (80 to 90%) and to a lesser extent branched paraffins as well as cycloparaffins. When the wax is of synthetic origin, it can belong to the hydrocarbon compounds obtained by reforming, to halogenated naphthalene compounds and to ethylene and vinyl polymers. Advantageously, the wax is selected from ethylene and vinyl polymers and polyolefins. Examples of synthetic waxes well suited to the invention are polypropylene, polytetrafluoroethylene (PTFE), polyvinyl alcohol as well as mixtures thereof.

The glass article of the invention comprises at least one wax, which is present in the enamel-based coating. Alternatively, the glass article of the invention comprises at least one wax, which is present on the enamel-based coating. As a further alternative, the glass article of the invention comprises at least one wax, which is present in the enamel-based coating and on the enamel-based coating.

According to a first particular embodiment of the invention, the wax is present in the composition of the enamel-based coating. According to such an embodiment, the wax can be homogeneously distributed in the composition of the coating. Alternatively, the wax can be heterogeneously distributed in the composition of said coating. For example, the wax can be present in the thickness of the enamel-based coating, but close to its surface (that in contact with the external medium).

Still according to this embodiment, the composition of the enamel-based coating contains between 0.1 and 20% by weight of wax. Too small a quantity of wax would not enable the desired effect to be obtained. Too large a quantity of wax beyond a certain value will not contribute anything and even represents a disadvantage in economic and ecological terms in that this wax is subsequently burned during the thermal treatment. The composition of the enamel-based coating preferably contains 0.2 to 10% by weight of wax.

According to this embodiment the glass article is obtained using a process comprising the following steps in sequence:
(a) mixing the enamelled composition and the wax;
(b) depositing the enamelled composition containing the wax onto the glass sheet in order to form a coating; and
(c) drying and/or cross-linking the coating.

In the step of mixing the enamelled composition and the wax, the wax can be in the form of a fine powder, in the form of a more or less viscous liquid or is previously dispersed or dissolved in a liquid medium that can be composed of water, one or more solvents, a polymer matrix, one or more resins and/or a plasticiser, a wetting agent etc. In one of the aforementioned forms, the wax is added directly to the enamelled composition, which is preferably in the form of a more or less viscous liquid. The resulting composition can then be mixed in a known manner.

Different methods known per se can be suitable for depositing the enamelled composition containing the wax onto the glass sheet. For example, it is possible to deposit the enamelled composition using a curtain coating process (onto a moving glass sheet) or by a sputtering process. The method of screen printing can also be used, in particular when only some portions of the glass sheet have to be covered.

After the step of depositing the enamelled composition, the enamelled composition is dried and/or cross-linked (if it contains cross-linkable elements), e.g. by means of heat (in a furnace, for example) and/or by means of UV or IR rays. This step allows the coating to harden and adhere to the glass sheet. At this stage the enamel is not yet molten or sintered. For example, if a cross-linkage step by IR radiation (presence of cross-linkable elements) is considered, this step is preferably conducted at a temperature of at least 150° C. and/or not exceeding 300° C., for 1 to 20 minutes in a static oven or for 5 to 10 minutes in an industrial oven. The temperature at the surface of the glass will preferably not exceed 250° C.

According to a second particular embodiment of the invention, the wax is present on the enamel-based coating. Wax present on the coating is understood to mean that the wax is deposited onto the coating, but does not form part of its composition.

The wax is preferably present on the enamel-based coating in the form of a film. According to an embodiment of the invention, the film can be formed predominantly from wax. According to the invention the film can preferably comprise at least 80% wax and more preferred at least 90% wax. The wax film according to the invention can comprise minor constituents such as wetting agents or mineral fillers, for example.

The wax is also preferably in direct contact with the enamel-based coating.

According to the invention, the film has a thickness that varies between 0.5 and 60 microns. Film thickness is also understood to mean the average geometric thickness.

According to this embodiment, the glass article is obtained by means of a process comprising the following steps in order:
(a) depositing the enamelled composition onto the glass sheet to form a coating;
(b) drying and/or cross-linking the enamel-based coating; and
(c) depositing the wax onto the enamel-based coating.

Different known methods already explained above can be suitable for depositing the enamelled composition onto the glass sheet.

After deposition of the enamelled composition, the obtained coating is dried and/or cross-linked in the same way as explained above.

The wax is then deposited onto the enamel-based coating using different known coating methods. Advantageously, the wax can be deposited onto the coating using a sputtering process. The wax in the form of a powder or a more or less viscous liquid is preferably firstly dispersed or solubilised in a liquid medium that can be composed of water, one or more solvents, a polymer matrix, one or more resins and/or a plasticiser, a wetting agent etc.

If the wax is deposited onto the glass sheet using a dispersion in a medium containing at least one solvent and/or water, an additional drying step may be required. Classically, it could be achieved by heating the glass sheet to a suitable temperature to cause evaporation of the solvent and/or water. Advantageously, the heat used for the preceding step of drying/cross-linking the enamel-based coating can be used for this step.

According to a third particular embodiment of the invention, the glass article comprises at least one wax that is present in the coating or on the coating. Consequently, this embodiment combines the first two embodiments explained above.

According to this third embodiment, the glass article is obtained by means of a process comprising the following steps in order:
(a) mixing the enamelled composition and a wax;
(b) depositing the enamelled composition containing the wax onto the glass sheet to form a coating;
(c) drying and/or cross-linking the coating; and
(d) depositing a wax onto the enamel-based coating.

According to this embodiment, the wax present in the coating is the same as the wax present on the coating. Alternatively, the wax present in the coating is different from the wax present on the coating.

In general, the article according to the invention can be thermally treated, in particular it can be thermally treated with a view to being subsequently toughened or also in order to be bent. Thermal treatment is understood to mean a treatment at temperatures that are not lower than 500° C., preferably not lower than 600° C. The drying and/or cross-linkage step therefore does not constitute a “thermal treatment” in the sense of the invention. When the article according to the invention is thermally treated, the enamel-based coating melts and sinters and the wax, which is exclusively organic in nature, is burned. The invention therefore covers an article that has not been thermally treated, but that is able to be thermally treated (reference is made to an article that is “toughenable” or “bendable”).

Articles in accordance with the invention can have various applications. These articles can be used, for example, for decorative applications on a single face or both faces, such as furniture doors, partitions, wall coverings, shelves, tables, balustrades etc. They can also be used for automotive applications such as windscreens, for example, if the enamel-based coating is applied along the periphery of the glass sheet.

The enamel-based coating of the invention can be coloured for decorative applications. If the article is thermally treated, the colour can change during the treatment depending on the composition of the coating. If this occurs, it is possible to take this into consideration and adapt the enamelled composition so that the colour of the glass article after its thermal treatment is the desired colour.

The following examples illustrate the invention without intending to restrict its coverage in any way.

### EXAMPLE 1 (COMPARATIVE)

A 4 mm thick sheet of clear float glass was transported on a belt conveyor. It is firstly washed in a normal manner. It then passes under a curtain applicator where it is coated with an enamelled composition. The enamelled composition deposited onto the glass sheet comprises:
82% by weight of a white enamel from FENZI (TEMPVER bianco 3302-928A);
9% by weight of a “Clearcoat” from FENZI; and
9% by weight of solvent (Exsol D40).

The coating obtained is then dried and cross-linked at a temperature of 185° C. for 5 minutes. The thickness of the coating is approximately 50 microns.

The coated glass sheet is then placed onto rubber belts to enable it to be cut and ground. It is then washed in an industrial washing machine, then toughened in a known manner (heating in a furnace at 670° C. for 3 minutes followed by rapid cooling to ambient temperature).

The glass sheet that has been in contact with the belts has marks, which are reduced after washing but do not disappear completely. They are also still present after the toughening operation.

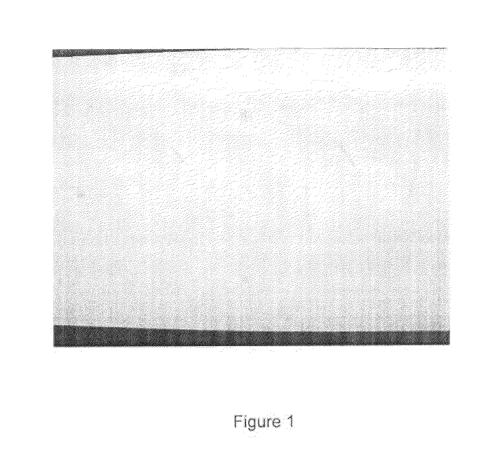

FIG. 1 shows a photograph of the glass sheet treated as below after toughening. It illustrates that the bands cause unsightly marks to appear on the white coating that do not disappear after the toughening operation.

### EXAMPLE 2 (COMPARATIVE)

A 4 mm thick sheet of clear float glass was transported on a belt conveyor. It is firstly washed in a normal manner. It then passes under a curtain applicator where it is covered with an enamelled composition. The enamelled composition deposited on the glass sheet comprises:
82% by weight of a black enamel from FENZI (TEMPVER nero 3400-13990A);
9% by weight of a “Clearcoat” from FENZI; and
9% by weight of solvent (Exsol D40).

The coating obtained is then dried and cross-linked at a temperature of 185° C. for 5 minutes. The thickness of the coating obtained is approximately 50 microns.

The coated glass sheet is then placed onto rubber belts to enable it to be cut and ground. It is then washed in an industrial washing machine, then toughened in a known manner (heating in a furnace at 670° C. for 3 minutes followed by rapid cooling to ambient temperature).

The glass sheet that has been in contact with the belts has marks, but these are not as visible as in the preceding example because of the black colour. These marks are reduced after washing but do not disappear completely. They are also still present after the toughening operation.

### EXAMPLES 3-15 (ACCORDING TO THE INVENTION)

4 mm thick sheets of clear float glass were transported on a belt conveyor. They are firstly washed in a normal manner. They then pass under a curtain applicator where they are coated with an enamelled composition. The enamelled composition deposited on the glass sheets is either:
composition 1: 82% by weight of a white enamel from FENZI TEMPVER bianco 3302-928A), 9% by weight of a “Clearcoat” from FENZI and 9% by weight of solvent (Exsol D40); or
composition 2: 82% by weight of a black enamel from FENZI (TEMPVER nero 3400-β3990A) and 9% by weight of a “Clearcoat” from FENZI and 9% by weight of solvent (Exsol D40),

to which wax has been added.

The waxes used are Lancowax waxes supplied by Lubrizol with the reference lanco TF1778 (polytetrafluoroethylene) and lanco PP1350 (polypropylene). These waxes have been incorporated into the enamelled composition as they are, i.e. in powder form or dispersed in a liquid medium. The dispersions that were used are:
dispersion 1: 32% by weight of wax dispersed in a mixture of polyester and melamine; and
dispersion 2: 20% by weight of wax dispersed in an aliphatic mineral oil distillate obtained between 140-200° C. (reference ED40).

The coating obtained is then dried and cross-linked at a temperature of 185° C. for 5 minutes. The thickness of the coating obtained is approximately 50 microns.

The coated glass sheets are then put into storage and stored in piles. For cutting and grinding they are placed onto rubber belts to enable them to be handled and transported. They are then washed in an industrial washing machine, then toughened in the same way as in the comparative examples.

The table shows the quantity and form of the wax added to the enamelled composition (1 or 2) and the visual evaluation of the black marks after cutting and grinding, after washing in the washing machine and after the toughening operation for each of Examples 3 to 15.

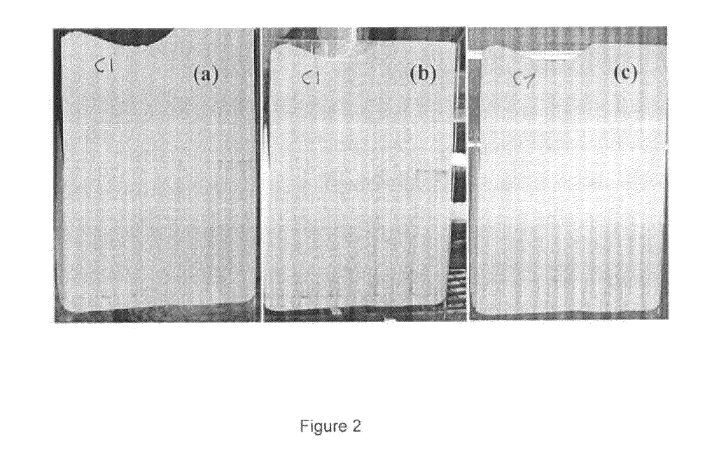

FIG. 2 shows photographs of the article of Example 4 (a) after handling and transport on the belts, (b) after cleaning in the washing machine and (c) after toughening. These images clearly illustrate that:
the belts cause unsightly marks to appear on the white coating, but that this has a pleasing appearance after drying/cross-linkage,
the marks fade slightly after washing, but this treatment is not sufficient; and
the marks have completely disappeared after the toughening operation.

These facts are also illustrated on the basis of the table and the visual evaluation of the marks. Hence, these examples enable it to be shown that the marks cannot be prevented by using wax within the enamel-based coating but that these are clearly seen to disappear when the product is toughened.

### EXAMPLE 16 (ACCORDING TO THE INVENTION)

A 4 mm thick sheet of clear float glass was transported on a belt conveyor. It is firstly washed in a normal manner. It then passes under a curtain applicator where it is coated with an enamelled composition. The enamelled composition deposited onto the glass sheet comprises:
82% by weight of a white enamel from FENZI (TEMPVER bianco 3302-928A);
9% by weight of a “Clearcoat” from FENZI; and
9% by weight of solvent (Exsol D40).

The coating obtained is then dried and cross-linked at a temperature of 185° C. for 5 minutes. The thickness of the coating is then approximately 50 microns.

An aqueous dispersion of 5% by weight of wax of reference 0730E supplied by Michelman (polyvinyl alcohol) was then applied to the enamel-based coating by sputtering at a rate of 20 g of dispersion/m² surface area of glass while the glass sheet having come out of the furnace had a temperature of about 60° C.

The coated glass sheet is then placed onto rubber belts to enable it to be handled and transporting during cutting and grinding. It is then washed in an industrial washing machine, then toughened in the same way as in the preceding examples.

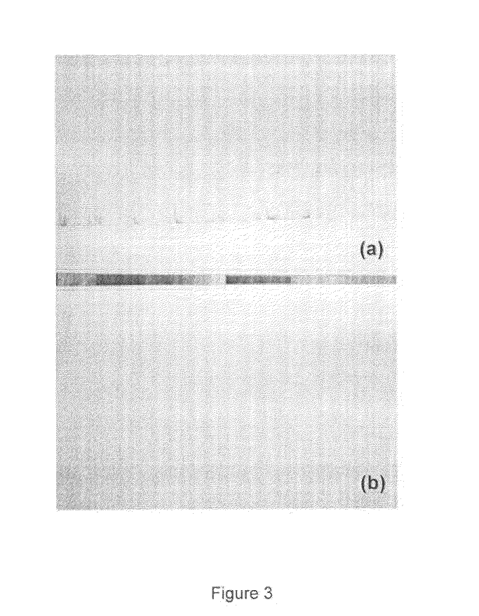

FIG. 3 shows photographs of Example 16 (a) after handling and transport on the belts and (b) after toughening. These images clearly illustrate that the belts cause unsightly marks to appear on the white coating and that the marks have completely disappeared after the toughening operation.

Therefore, these photographs illustrate that the use of wax on the enamel-based coating does not enable the marks to be prevented but that these are clearly seen to disappear when the product is toughened.

TABLE

| | | | | % wt. of wax | | | |
|---|---|---|---|---|---|---|---|
| | | | | added to the | Visual evaluation of the marks* | | |
| | Enamelled | Type of | | enamelled | after | after | after |
| Ex | composition | wax | Form of wax | composition | cutting/grinding | washing | toughening |
| 3 | Composition 1 | TF1778 | dispersion 1 | 0.32 | 1/5 | 2/5 | 4/5 |
| 4 | | TF1778 | dispersion 1 | 0.8 | 1/5 | 2/5 | 4/5 |
| 5 | | TF1778 | dispersion 1 | 1.6 | 1/5 | 2/5 | 4/5 |
| 6 | | TF1778 | dispersion 2 | 0.20 | 1/5 | 2/5 | 4/5 |
| 7 | | TF1778 | dispersion 2 | 0.5 | 1/5 | 2/5 | 5/5 |
| 8 | | TF1778 | dispersion 2 | 1 | 1/5 | 2/5 | 4/5 |
| 9 | | PP1350 | powder | 1 | 1/5 | 2/5 | 4/5 |
| 10 | | PP1350 | powder | 2.5 | 1/5 | 2/5 | 4/5 |
| 11 | | PP1350 | powder | 5 | 1/5 | 2/5 | 4/5 |
| 12 | Composition 2 | TF1778 | dispersion 1 | 1 | 3/5 | 4/5 | 5/5 |
| 13 | | TF1778 | dispersion 1 | 5 | 3/5 | 4/5 | 5/5 |
| 14 | | PP1350 | powder | 1 | 3/5 | 4/5 | 5/5 |
| 15 | | PP1350 | powder | 5 | 3/5 | 4/5 | 5/5 |

*visual evaluation
5/5 = no mark;
4/5 = barely visible marks (product suitable for sale); and
3/5: not very visible marks,
2/5: visible marks,
1/5: highly visible marks and
0/5: highly visible marks of very intense colour (product unsuitable for sale).

1. An article comprising:
a glass sheet;
an enamel-based coating on a surface of the glass sheet; and
a wax in the coating, on the coating, or both.

2. The article of claim 1, wherein the coating comprises 11 to 40% by weight of an organic material.

3. The article of claim 1, wherein the wax is in the coating.

4. The article of claim 1, wherein the coating comprises between 0.1 and 20% by weight of the wax.

5. The article of claim 1, wherein the coating comprises between 0.2 and 10% by weight of the wax.

6. The article of claim 3, wherein the wax is distributed homogeneously in the coating.

7. The article of claim 3, wherein the wax is distributed heterogeneously in the coating.

8. The article of claim 1, wherein the wax is on the coating as a film.

9. The article of claim 8, wherein the film comprises at least 80% wax.

10. The article of claim 9, wherein the film comprises at least 90% wax.

11. The article of claim 8, wherein the film has a thickness that varies between 0.5 and 60 microns.

12. The article of claim 8, wherein the wax is in direct contact with the coating.

13. The article of claim 8, wherein the wax is in and on the coating.

14. The article of claim 1, wherein the wax is at least one selected from the group consisting of a wax of natural origin, a wax of synthetic origin, and any mixture thereof, in any proportion.

15. The article of claim 1, wherein the enamel-based coating is in direct contact with the glass sheet.

16. The article of claim 2, wherein the coating does not comprise more than 30% by weight of an organic material.

17. The article of claim 2, wherein the coating does not comprise more than 20% by weight of an organic material.

18. The article of claim 4, wherein the wax is distributed homogeneously in the coating.

19. The article of claim 4, wherein the wax is distributed heterogeneously in the coating.

20. The article of claim 9, wherein the wax is in direct contact with the coating.
